(19) United States
(12) Patent Application Publication
(10) Pub. No.: US 2019/0124887 A1
(43) Pub. Date: May 2, 2019

(54) TRAINING DEVICE

(71) Applicant: Dogprotect Oy, Tampere (FI)

(72) Inventor: Toni Seppälä, Tampere (FI)

(21) Appl. No.: 15/795,780

(22) Filed: Oct. 27, 2017

(51) Int. Cl. A01K 15/02; A01M 29/12; A01M 29/18; A01M 29/24

(52) U.S. Cl. CPC A01K 15/021; A01M 29/24; A01M 29/18; A01M 29/12

(57) ABSTRACT

A device for training a pet animal against a hazardous creature. The device includes: a body designed to resemble the hazardous creature; and a negative enforcement means arranged in the body. The negative enforcement means is operable to provide at least one deterrent signal to the pet animal upon establishing physical contact with the body or approaching towards the device.

### TECHNICAL FIELD

The present disclosure relates generally to training of pet animals; and more specifically, to a device for training the pet animals.

### BACKGROUND

In the changing social setup, number of people owning animals domestically has increased drastically. Generally, animals have a natural hunting instinct which drives them to find, pursue and capture a prey. However, a domesticated animal is kept away from a natural wild environment and is brought up in a protected domestic environment. Therefore, the natural hunting instinct in a domesticated pet animal is curbed during domestication. Thus, the pet animal is unable to determine the danger associated with different living creatures. For example, owing to its natural hunting instinct, a pet animal may approach any hazardous creature it confronts without being aware of impending danger associated the hazardous creature.

Conventionally, the pet animals are trained by their owners, by teaching various training commands, in an event the hazardous creature is confronted by the pet animals. Specifically, training commands like “leave it”; “stop” and so forth are taught to the pet animals. However, training a pet animal, such as a dog, with such training commands have certain limitations. For example, the pet animal may not obediently follow the commands given by the owner. Further, in absences of the owner the pet animal may approach or even establish contact with such hazardous creatures. In order to address above problems, alternatively pet owners may employ a remote controlled shock collar on their pet animals. Typically, such shock collars are operable to create an aversion, by providing a stimulus (i.e. an electric shock), to avoid confrontation with hazardous creatures. However, the fundamental problem with the conventional shock collar is the inherent inconsistency in delivery of the stimulus. Further, lack of consistency in the frequency and magnitude of the stimulus delivered by the shock collar confuses the pet animal rather training.

Therefore, in light of the foregoing discussion there exists a need to overcome the aforementioned drawbacks associated with the training of pet animals.

### SUMMARY

The present disclosure seeks to provide a device for training a pet animal against a hazardous creature. The present disclosure seeks to provide a solution to the existing problem of training the pet animal against a threat of the hazardous creature. An aim of the present disclosure is to provide a solution that overcomes at least partially the problems encountered in the prior art, and provides an efficient, reliable and a simple device that eliminates aforesaid problem in the existing training techniques.

In one aspect, an embodiment of the present disclosure provides a device for training a pet animal against a hazardous creature, the device comprising:
a body designed to resemble the hazardous creature; and
a negative enforcement means arranged in the body, wherein the negative enforcement means is operable to provide at least one deterrent signal to the pet animal upon establishing physical contact with the body or approaching towards the device.

Embodiments of the present disclosure substantially eliminate or at least partially address the aforementioned problems in the prior art, and allows for training of the pet animal by employing a prototype of the hazardous creature and thereby creating a real life situation.

Additional aspects, advantages, features and objects of the present disclosure would be made apparent from the drawings and the detailed description of the illustrative embodiments construed in conjunction with the appended claims that follow.

It will be appreciated that features of the present disclosure are susceptible to being combined in various combinations without departing from the scope of the present disclosure as defined by the appended claims.

### BRIEF DESCRIPTION OF THE DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those in the art will understand that the drawings are not to scale. Wherever possible, like elements have been indicated by identical numbers.

Embodiments of the present disclosure will now be described, by way of example only, with reference to the following diagrams wherein:

FIG. 1 illustrates a block diagram of a device for training a pet animal against a hazardous creature, in accordance with an embodiment of the present disclosure; and

FIGS. 2 and 3 illustrate exemplary implementations of the device of FIG. 1, in accordance with various embodiments of the present disclosure.

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DETAILED DESCRIPTION OF EMBODIMENTS

The following detailed description illustrates embodiments of the present disclosure and ways in which they can be implemented. Although some modes of carrying out the present disclosure have been disclosed, those skilled in the art would recognize that other embodiments for carrying out or practising the present disclosure are also possible.

In one aspect, an embodiment of the present disclosure provides a device for training a pet animal against a hazardous creature, the device comprising:
a body designed to resemble the hazardous creature; and
a negative enforcement means arranged in the body, wherein the negative enforcement means is operable to provide at least one deterrent signal to the pet animal upon establishing physical contact with the body or approaching towards the device.

The present disclosure seeks to provide a reliable and effective solution, i.e. a device to train a pet animal against threat of a hazardous creature. The device enhances alertness of the pet animal and reduces involvement of the pet owner. Beneficially, the body of the device resembles the hazardous creature, and therefore allows the pet animal to be alert or cautious upon real life confrontation with such hazardous creature. Furthermore, the device allows the pet owner to occasionally leave the pet animal physically unattended. For example, the owner may leave the pet animal physically in a park or backyard and still be ensured about safety of the pet animal. Moreover, the device of the present disclosure is operable to provide a warning signal in a consistent manner, thereby allowing the pet owner to appropriately train the pet animal.

As mentioned previously, the device for training a pet animal against the hazardous creature comprises the body. Specifically, the body is designed to resemble the hazardous creature. The hazardous creature relates to an animal possessing at least one life threatening ability for the pet animal. Examples of such hazardous creature include, but are not limited to, snakes, scorpions, Tarantula spiders and lizards. Further, the pet animal relates to an animal that is kept primarily in a domestic environment. Examples of pet animal include, but are not limited to dogs, cats, horse, tortoise, rabbits, and guinea pigs.

According to an embodiment, the term “body” relates to a physical structure having close resemblance to the hazardous creature. In an example, the physical structure of the body may be designed to resemble a snake. In another example, the physical structure of the body may be designed to resemble a Tarantula spider.

Optionally, the body comprises at least two parts, the at least two parts are moveably connected to each other. More optionally, the at least two parts are arranged to be enclosed within the body. In an example, the body may include two parts or more than two parts such as six parts, and such parts are moveably connected to each other. Alternatively, the body may include one part to resemble a particular hazardous creature. In an embodiment, the body is fabricated using a flexible material. For example, the flexible material includes, but not limited to, silicon, metallic rubber, or conductive polymers. Additionally, the body may be fabricated using materials such as, plastic, metal and the like.

Additionally, optionally, the device further comprises mechanical wheels to provide movement to the body. The wheels are provided to move the body in a forward or backward direction, with respect to a ground surface. In an example, the body of the device may resemble a snake and the device may include two wheels under a head section of the body. Further, the wheels are configured to move the body (i.e. the snake) with respect to the ground surface.

In one embodiment, the device further comprises an actuator operable to move the at least two parts with respect to each other. It will be appreciated that the actuator is configured to provide movement to the at least two parts of the body with respect to each other. Optionally, the actuator is arranged between the at least two parts of the body. More optionally, the actuator is configured to provide a movement to the at least two parts of the body so as to resemble the movement of the hazardous creature. In an example, the actuator comprises a motor and a pair of connecting links. The pair of connecting links are attached to the at least two parts of the body and to a shaft of the motor, thereby providing movement to the at least two parts of the body with the rotation of the shaft of the motor.

In an embodiment, when an owner (or trainer/coach) of a pet animal (for example, such as a dog), wants to train the dog against a hazardous creature (for example, such as a venomous snake). In such an instance, the owner may employ a device having a body resembling the venomous snake. Further, the device may include an actuator configured to provide movement to the at least two parts of the body of the device to resemble movement of the venomous snake.

As mentioned previously, the negative enforcement means is arranged in the body, and the negative enforcement means is operable to provide at least one deterrent signal to the pet animal upon establishing physical contact with the body or approaching towards the device. Throughout the present disclosure, the term “negative enforcement means” relates to a set of equipment configured to provide a negative indication to the pet animal upon establishing the physical contact with the body or approaching towards the device. Further, throughout the present disclosure, the term “deterrent signal” relates to an indication provided to the pet animal, via the negative enforcement means. In an example, the deterrent signal may be an indication that can be directly perceived by the pet animal. Furthermore, it will be appreciated that the physical contact of the pet animal and the body relates to physical interaction between the pet animal and the body of the device. In an example, a physical contact may be established, by a pet animal (for example, such as a dog), by sniffing or biting the body of the device. In such an instance, the device is configured to detect the physical contact and provide the at least one deterrent signal to the pet animal.

According to an embodiment, the at least one deterrent signal to the pet animal is provided when the pet animal is in close proximity of the device and is about to establish the physical contact with the body of the device. In such a case, the device is configured to estimate a distance between the pet animal and the device to detect the proximity therein. In an embodiment, the distance between the pet animal and the device, for providing the deterrent signal, is predefined by the owner. For example, distance between the pet animal and the device for providing the deterrent signal may be predefined as two metres, one meter or for example 20 centimetres or closer. Therefore, when the pet animal is within two metres distance from the device, the device may detect such presence of the pet animal and provide the at least one deterrent signal to the pet animal.

Optionally, the device further comprises a sensor for detecting at least one of physical contact by the pet animal with the body of the device and presence of the pet animal approaching towards the device. In an example, the sensor includes at least one of: a motion detection sensor; a proximity sensor. It will be appreciated that the motion detection sensor is configured to detect the physical contact by the pet animal with the body of the device, and the proximity sensor is configured to detect the movement and presence of the pet animal approaching the body. Examples of the motion detection sensor and the proximity sensor may include, but are not limited to vibration sensor, ultrasonic sensor, passive motion detector sensor, active motion detector sensor, infrared sensor, and Hall Effect sensors.

Optionally, the negative enforcement means is an electrical output setup which setup comprises an electricity source for providing high voltage output. Furthermore, the electrical output setup also comprises a conducting element connected to the electricity source. Moreover, the conducting element is arranged in an outer surface of the body. It will be appreciated that the electricity source comprises a battery such as Alkaline, Lithium, Nickel-Cadmium (Ni—Cd) and the like. In an embodiment, the size of the battery (for example such as button cells, AA, AAA) can be varied to fit the device. In an example, a battery such as AA alkaline battery may be used in the device to act as the electricity source.

In one embodiment, the electricity source may be a flexible battery such as, but not limited to, lithium polymer battery Magnesium-ion battery, molten salt battery, Nickel-cadmium battery and so forth. Optionally, the electricity source may be rechargeable. Alternatively, optionally, the electricity source may be non-rechargeable.

Furthermore, optionally, the electricity source is placed inside the body of the device. In one embodiment, the electricity source is removable from the body. Beneficially, the removable electricity source allows easy replacement of the batteries. In another embodiment, the electricity source is fixedly arranged on the body of the device. In such an embodiment, the body comprises an input port for recharging such electricity source. In such a case, the input port allows for the electricity source to receive the electrical power from an external power source. Throughout the present disclosure the term “high voltage output” relates to an electric voltage provided by the electricity source to the conductive element. It will be appreciated that the electric voltage, supplied by the electricity source such as a battery, is boosted using a step-up converter to achieve the high voltage output. Optionally, the step-up converter is used to step up the input voltage provided to the circuit such that a higher voltage is obtained at the output. In an example, the voltage output of the battery is 10 volts. In such an example, the step-up converter is operable to boost the voltage output to 5000 volts. It will be appreciated that the high output voltage is provided in such a manner that the pet animal is not injured.

More, optionally, the high voltage output ranges between 5-3000 volts and operable to generate a current ranging between 5 to 20 milli-ampere. More optionally the high voltage output ranges can be between 500 to 3000 volts. Optionally the high voltage output range can be between 800 to 1200 volts. The current range is selected in such a manner that output power is limited not to harm the pet animal. Furthermore, optionally, the conducting element allows the current of high output voltage to pass therethrough. In an embodiment, the conducting element may comprise a conductor made up of materials including but not limited to metals, semiconductors, polymers and the like. In such an embodiment, a metal conductor (for example such as copper, silver, aluminium) may be used as the conducting element. It will be appreciated that the conducting element is arranged on the outer surface of the body. In an embodiment the conducting element is arranged in such a manner so as to cover the body completely. In another embodiment, the conducting element may be restricted to only top surface of the body such that the deterrent signal is not conducted to earth.

Optionally, the conducting element comprises at least one of: a wire, a pad or a conducting surface. In an embodiment, the conducting element is made of a copper wire which connects the deterrent signal from the electricity source to the outer surface of the body. In another embodiment, the conducting element is a conducting pad. In such an embodiment, the conducting pad is arranged on a specific portion of the outer surface of the body. For example, the conducting element is arranged on head of the body. In yet another embodiment, the conducting element is a conductive coating arranged over the outer surface of the body. For example, graphene along with polymer may be coated over the outer surface of the body to act as the conducting element and pass the electric current therethrough. In yet another embodiment, the conductive element comprises the wire and the conductive surface. In such an embodiment, the wire is connected with the electricity source at one end and with the conductive surface at another end.

Optionally, the at least one deterrent signal comprises providing an electric shock to the pet animal when the pet animal establishes physical contact with the body. It will be appreciated that magnitude of the electric shock provided to the pet animal is consistent and the pet animal is not injured. Accordingly, when the pet animal physically touches the device, the pet animal experiences an electric shock and such electric shock creates a fear in the mind of the pet animal and makes the pet animal aware about the harms associated with similar looking creatures.

In one embodiment, the negative enforcement means is a liquid output setup, which setup comprises a reservoir for storing a liquid repellent and a pump unit configured to spray the liquid repellent. Additionally, the reservoir is installed within the body or outside the body. Also, the reservoir may be detachably coupled to the body. Optionally, the reservoir is made of plastic material. Moreover, the reservoir is made of an elastic material to be easily mouldable inside the body of the device. Furthermore, the material employed to fabricate the reservoir can withstand pressure exerted on the body in case of physical interaction with the pet animal. Optionally, the reservoir is operable to be refilled with the liquid repellent when the liquid repellent finishes. The liquid repellent relates to a fluid that is repulsive in nature to the pet animal. In an example, a reservoir may contain vinegar or citrus juice as the liquid repellent.

Optionally, the liquid output setup comprises the pump unit. The pump unit is configured to spray the liquid repellent by mechanical action. It will be appreciated that the pump unit is located in the reservoir in such a manner that the pump unit is submerged in the liquid repellent. Further, the pump unit is designed to be activated upon detecting the movement or presence of the pet animal by the sensor. Specifically, the pump unit is used to push air into a partially filled reservoir to create a pressure difference therein, and subsequently the liquid repellent is pressurized (or sprayed) by the compressed air.

Optionally, the pump unit further comprises a nozzle valve. It will be appreciated that upon opening the nozzle valve, the pressurized liquid repellent is pushed out through a nozzle. Thus, allowing production of a continuous stream of the liquid repellent, which may be directed towards the pet animal.

According to an embodiment, the at least one deterrent signal comprises spraying the liquid repellent on the pet animal when the pet animal approaches the body. It will be appreciated that the pump unit may be triggered or activated by the proximity sensor. The pump unit thereby sprays the liquid repellent through a nozzle valve. Optionally, the nozzle valve may be present on a top outer surface of the body, for example in the head section of the body. Furthermore, the nozzle valve may be evenly distributed over the top outer surface of the body.

In an alternative embodiment, the negative enforcement means is an ultrasonic sound source. According to the alternative embodiment, at least one deterrent signal comprises outputting with audio means a high frequency ultrasonic sound.

In an alternative embodiment, the negative enforcement means is a vibrator. According to the alternative embodiment, at least one deterrent signal comprises moving rapidly (vibrating) the device body.

According to an embodiment the device might comprise more than one negative enforcement means. For example the device might comprise both an electrical output setup and a liquid output setup as negative enforcement means. As an other example the device might comprise an electrical output setup and an ultrasonic sound source. As a further example the device might comprise an electrical output setup, a liquid output setup, an ultrasonic sound source and a vibrator as negative enforcement means. In general any combination of means can be applied. Number of negative enforcement means can be also one i.e. for example only the electrical output setup.

In an embodiment, the device further comprises a processing unit and a communication interface. The processing unit is configured to receive an activation signal over the communication interface to activate the negative enforcement means. The processing unit relates to a computational element that is operable to, receive and process instructions to activate the negative enforcement means. In an embodiment, the processing unit is implemented by way of hardware, software, firmware or a combination of these, suitable for activating the negative enforcement means. Optionally, the processing unit includes, but is not limited to, a microprocessor, a microcontroller, a complex instruction set computing (CISC) microprocessor, a reduced instruction set (RISC) microprocessor, a very long instruction word (VLIW) microprocessor. Furthermore, optionally, the processing unit refers to one or more individual processors, processing devices and various elements associated with a processing device that may be shared by other processing devices. Consequently, employing one or more processing unit enhances response time of the device. Additionally, the one or more individual processors, processing devices and elements are arranged in various architectures for receiving and processing instructions. In an example, the processing unit may be located inside the body of the device.

In an embodiment, the processing unit is operatively coupled to the communication interface. Beneficially, the coupling of processing unit and communication interface enables an exchange of the activation signal and instructions. The communication interface relates to an arrangement of interconnected programmable and/or non-programmable components that are configured to facilitate communication between one or more electronic devices, software modules and/or databases.

Throughout the present disclosure, the term “activation signal” relates to a definitive stimulus operable to activate the negative enforcement means. It will be appreciated that the activation signal is communicated over the communication interface. The processing unit further communicates the activation signal to the negative enforcement means. Accordingly, the negative enforcement means provide the at least one deterrent signal to the pet animal based on the activation signal. In an example, the activation signal may be audible in nature. In such an example, the owner may provide an audible command to the device to activate the negative enforcement means. In another example, the activation signal may be received from the sensors, present in the body of the device.

In an embodiment, the processing unit is configured to receive operational instructions over the communication interface to control the high voltage output. Throughout the present disclosure, the term “operational instructions” relates to a set of steps or commands that include information of controlling operation of the negative enforcement means. Specifically, the operational instructions define a limit for controlling the high voltage output. In an example, for a particular pet animal, an owner may set the high voltage output in such a manner that the pet animal is not injured during the training with the set high voltage.

Optionally, the operational instructions are stored in the processing unit. In such a case, the processing unit includes a memory unit. It will be appreciated that the memory unit is operable to store the operational instructions. In an example, the memory unit may be hard disk drives or other external storage devices. The operational instructions may also include providing current of 7 milli ampere for 10 seconds. Alternatively, optionally, the processing unit receives the operational instructions from a mobile phone (or smart phone or tablet computer) of the owner.

In an embodiment, the processing unit is further configured to receive movement instructions over the communication interface for controlling movement of the device. Throughout the present disclosure, the term “movement instructions” relate information regarding the pattern of movement of the device with respect to the ground surface. It will be appreciated that movement instructions includes information related to controlling movement of the at least two parts of the body on varied terrains. For example, the movement instructions are operable to coordinate the movement of the actuator and the wheels. Optionally, the device may move according to pre-defined movement instructions defined by the owner. Additionally, optionally, the device may move according to real time input provided by the owner. In another example, an owner may engage a remote controller to provide movement instructions to the device. In yet another example the remote controller can be used to control the deterrent signal output (i.e. for example activate electric shock, activate ultrasound, activate spray etc).

According to an embodiment, the device further comprises a reservoir for holding an odor concentrate associated with the odor of the hazardous creature. Beneficially, such odor concentrate helps the pet animal to determine presence of the hazardous creature in its proximity, particularly, when the hazardous creature is not visible to the pet animal. It will be appreciated that the odor concentrate stored in the reservoir may be in a solid, liquid or gaseous state. Optionally, the reservoir is made of an elastic material to be easily mouldable inside the body of the device. Furthermore, the material employed to fabricate the reservoir can withstand pressure exerted on the body in case of physical interaction with the pet animal. Additionally, the reservoir may be designed such that it is possible to dispose or refill the odor concentrate.

According to another embodiment, the device further comprises an audio source to mimic and produce a sound of the hazardous creature. It will be appreciated that the audio source is employed to produce an added effect of the hazardous creature. For example, the audio source includes a speaker for generating the sound of the hazardous creature. In an example, the sound may be a hissing sound of a snake. In another example, the sound may be a rattling sound of a rattlesnake.

In an exemplary embodiment, the reservoir for holding the odor concentrate and the audio source may also be employed as negative enforcement means. In such an embodiment, when the pet animal is in proximity of the device, the negative enforcement means gets activated and emits the odor of the associated hazardous creature to warn the pet animal about presence of the impending danger. Further, if the pet animal is still not aware of the hazardous creature, the audio source may also generate audio associated with the hazardous creature. In such instance, if the pet animal is still approaching the device, the negative enforcement means may get activated and spray the liquid repellent on the pet animal. Finally, if the pet animal establishes the physical contact with the device, the electric shock is provided to the pet animal.

Alternatively the hazardous creature can considered to be a piece of food such as piece of meat or sausage. The food can be hazardous for example if there are foreign objects in the food (such as razor blades), if the food is rotten, if the food is poisoned or if the pet is allergic to said food (as an example dogs are typically allergic to chocolate). In said deterrent signal means are attached/embedded in the piece of food. Further proximity sensing means can be attached to the piece of food. In said arrangement pet can be trained not to pick up food from street/nature or in any other place expect the designated feeding area of the pet.

### DETAILED DESCRIPTION OF THE DRAWINGS

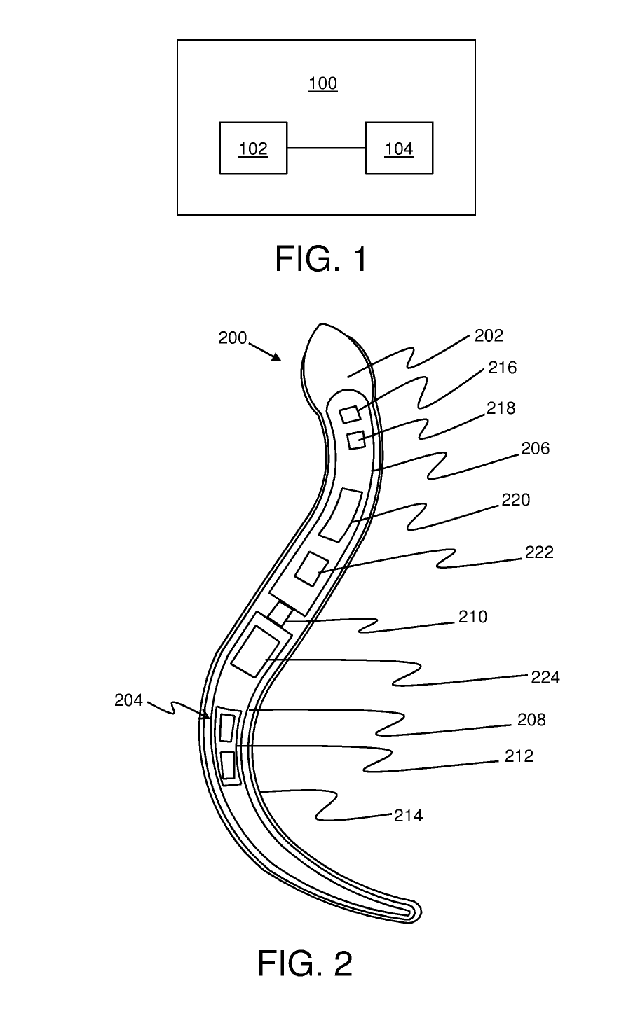

Referring to FIG. 1, there is shown a block diagram of a device 100 for training a pet animal (not shown), in accordance with an embodiment of the present disclosure. As shown, the device 100 comprises a body 102 designed to resemble a hazardous creature. The device 100 further comprises a negative enforcement means 104 arranged in the body 102. The negative enforcement means 104 is operable to provide at least one deterrent signal to the pet animal upon establishing physical contact with the body 102 or approaching towards the device 100.

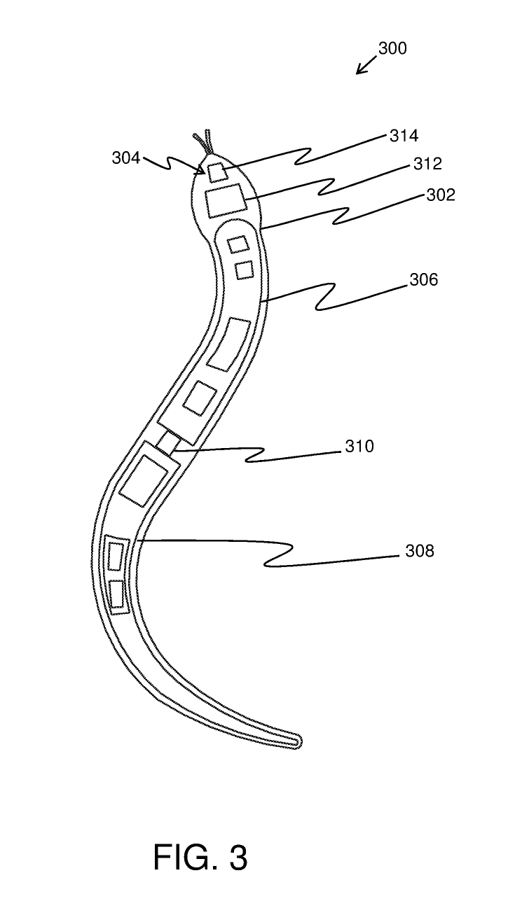

Referring to FIG. 2, there is shown exemplary implementation of a device 200 (such as the device 100 of FIG. 1), in accordance with an embodiment of the present disclosure. As shown, the device 200 comprises a body 202 designed to resemble a hazardous creature, i.e. a snake. The body 202 comprises at least two parts, depicted herein as two parts 206 and 208. The at least two parts 206, 208 are moveably connected to each other. The device 200 further comprises an actuator 210 operable to move the at least two parts 206, 208 with respect to each other.

The device 200 further comprises a negative enforcement means 204 arranged in the body 202. The negative enforcement means 204 is operable to provide at least one deterrent signal to the pet animal upon establishing physical contact with the body 202 or approaching towards the device 200. The at least one deterrent signal comprises providing an electric shock to the pet animal when the pet animal establishes physical contact with the body 202. The negative enforcement means 204 accordingly comprises an electricity source 212 for providing a high voltage output, and a conducting element 214 connected to the electricity source 212. The conducting element 214 is arranged on outer surface of the body 202.

The device 200 also comprises a reservoir 216 for holding an odor concentrate, associated with an odor of the hazardous creature. The device 200 also comprises an audio source 218 to generate a sound of the hazardous creature. The device 200 further comprises a processing unit 220 and a communication interface 222. The processing unit 220 is configured to receive an activation signal over the communication interface 222 to activate the negative enforcement means 204. The processing unit 220 is configured to receive operational instructions over the communication interface 222 to control the high voltage output. The processing unit 220 is also configured to receive movement instructions over the communication interface 222 for controlling a movement of the device 200. The device 200 further comprises a sensor 224 for detecting at least one of: physical contact by the pet animal; presence of the pet animal approaching the body 202. The sensor 224 is at least one of: a motion detection sensor; a proximity sensor.

Referring to FIG. 3, there is shown exemplary implementation of a device 300 (for example, such as device 200 of FIG. 2), in accordance with another embodiment of the present disclosure. The device 300 is similar to the device 200 of FIG. 2. For example, the device 300 comprises a body 302, at least two parts, depicted as two parts 306, 308, an actuator 310 (structurally and functionally similar to the body 202, the two parts 206, 208 and the actuator 210, respectively, of the device 200) and a negative enforcement means 304. However, the negative enforcement means 304 comprises a reservoir 312 for storing a liquid repellent, and a pump unit 314 configured to spray the liquid repellent. Accordingly, the at least one deterrent signal comprises spraying the liquid repellent on the pet animal when the pet animal approaches towards the body. It will be appreciated that the device 300 also includes a negative enforcement means, such as the negative enforcement means 204 having the electricity source 212 and the conducting element 214, of the device 200.

Modifications to embodiments of the present disclosure described in the foregoing are possible without departing from the scope of the present disclosure as defined by the accompanying claims. Expressions such as “including”, “comprising”, “incorporating”, “have”, “is” used to describe and claim the present disclosure are intended to be construed in a non-exclusive manner, namely allowing for items, components or elements not explicitly described also to be present. Reference to the singular is also to be construed to relate to the plural.

1. A device for training a pet animal against a hazardous creature, the device comprising:
a body designed to resemble the hazardous creature; and
a negative enforcement means arranged in the body, wherein the negative enforcement means is operable to provide at least one deterrent signal to the pet animal upon establishing physical contact with the body or approaching towards the device.

2. A device according to claim 1, wherein the body comprises at least two parts, the at least two parts are moveably connected to each other.

3. A device according to claim 2, further comprising an actuator operable to move the at least two parts with respect to each other.

4. A device according to claim 1, wherein the negative enforcement means is an electrical output setup which setup comprises:
an electricity source for providing a high voltage output, and
a conducting element connected to the electricity source, the conducting element being arranged in an outer surface of the body.

5. A device according to claim 4, wherein the conducting element comprises at least one of: a wire, a pad or a conducting surface.

6. A device according to claim 4, wherein the at least one deterrent signal comprises providing an electric shock to the pet animal when the pet animal establishes physical contact with the body.

7. A device according to claim 4, wherein the high voltage output ranges between 5-3000 volts and operable to generate a current ranging between 5 to 20 milli-ampere.

8. A device according to claim 1, wherein the negative enforcement means is a liquid output setup, which setup comprises:
a reservoir for storing a liquid repellent, and
a pump unit configured to spray the liquid repellent.

9. A device according to claim 8, wherein the at least one deterrent signal comprises spraying the liquid repellent on the pet animal when the pet animal approaches the body.

10. A device according to claim 1, further comprising a reservoir for holding an odor concentrate associated with the odor of the hazardous creature.

11. A device according to claim 1, further comprising an audio source to generate a sound of the hazardous creature.

12. A device according to claim 1, further comprising a processing unit and a communication interface, wherein the processing unit is configured to receive an activation signal over the communication interface to activate the negative enforcement means.

13. A device according to claim 12, wherein the processing unit is configured to receive operational instructions over the communication interface to control the high voltage output.

14. A device according to claim 12, wherein the processing unit is configured to receive movement instructions over the communication interface for controlling movement of the device.

15. A device according to claim 1, further comprising a sensor for detecting at least one of physical contact by the pet animal; presence of the pet animal approaching the body.

16. A device according to claim 15, wherein the sensor is at least one of: a motion detection sensor; a proximity sensor.
